(19) United States
(12) Patent Application Publication
(10) Pub. No.: US 2002/0194120 A1
(43) Pub. Date: Dec. 19, 2002

(54) Consultative decision engine method and system for financial transactions

(76) Inventors: Jeffrey J. Russell, Ballwin, MO (US); Richard S. Gagliano, O'Fallon, MO (US)

Correspondence Address: BAKER & BOTTS, 30 ROCKEFELLER PLAZA, NEW YORK, NY, 10112

(21) Appl. No.: 10/145,263

(22) Filed: May 13, 2002

Related U.S. Application Data
(60) Provisional application No. 60/290,277, filed on May 11, 2001.

(51) Int. Cl. G06F 17/60

(52) U.S. Cl. 705/38

(57) ABSTRACT

The invention provides a method and system for providing and managing a ubiquitous financial services account for provision, interpretation, and evaluation of mortgage services by way of online automatic online services. The method can include automatic online services that are consultative in nature, i.e., services that coach a user to alter input in fashions that maximize the display of potential financial services products to the customer. For instance, the customer can be prompted to alter inputs relating to either his desired financial services products, or to his personal financial characteristics, in order to alter or favorably influence the display of financial services products for which he qualifies. As examples of the financial services products in connection with which the invention can be implemented, the invention can provide enhance borrower and lender options within a consumer mortgage shopping, application, and initiation transaction, though the range of financial service products (which can include multiple disparate or complementary products within an ongoing account or portfolio) that can be integrated in the invention is not limited to mortgage or credit-related products.

### BACKGROUND OF THE INVENTION

This Application claims priority from and incorporates in full by reference Provisional Application No 60/290,277, filed May 11, 2001.

The present invention relates to data processing systems for financial transactions, and in particular to methods and systems for a decision engine capable of determining what financial services produces a potential customer may be eligible for and offering a customized array of pricing options for those products in conjunction with consultative feedback provided to the customer by the decision engine on behalf of a financial services provider, for example, such that the customer is presented with a wide panoply of potential financial services products for which he is eligible, is prompted to consider financial services products of which he might not previously have been aware, and is aided in adjusting either his desired parameters or expectations for a financial services transaction, or his own eligibility characteristics, in order to obtain a mutually-desirable array of available financial services products from the provider to the customer.

In the financial services market as currently constituted, there exist a number of channels or financial services “products” through which customers, for instance individual persons, may enter into financial transactions with financial services providers. For instance, customers may seek a transaction in which they borrow money, typically by paying an interest or finance charge. Such borrowing may take multiple forms, as for instance a credit card, a first mortgage secured by a residence or other building, a home equity loan, an automobile or boat loan, a margin loan relating to credit that an investor may use in purchasing securities or other investment products, a student loan, a floating line of credit, a letter of credit, a payday loan, etc. This plurality of credit products is offered typically by a plurality of different varieties of lenders—e.g., commercial banks, savings banks, savings and loan associations, credit unions, credit card companies, loan servicing companies, finance companies, securities brokers, etc.

There also exist a variety of savings or investment products, which include cash management or money market accounts in which an individual customer may hold cash or cash equivalents (e.g., negotiable securities, certificates of deposits, or other credits), either on a short-term or long-term basis. As with margin loans, cash management accounts may be linked to investment accounts; e.g., a cash management account may serve as a cash reserve for future investments, or a holding account for the proceeds of securities sold by an investor, within a brokerage account. As with the disparate forms of loan products, there may exist several disparate forms of cash management product needed by a given customer, and in present practice such cash management accounts are not fully integrated with each other or with that consumer's loan account(s).

051 In the field of consumer loans, for instance home mortgage loans, lenders typically offer a standard listing of products and pricing (i.e., a rate sheet) for financial services products offered through their physical branches, by telephone sales fulfilled through call centers, and through the internet and/or World Wide Web (“WWW). These pricing sheets only cover the interest rate and point combinations currently offered by the institution. Accordingly, customers are not aided in searching for or customizing the products and pricing attributes that best meet their individual needs, but rather are steered toward a standardized set of available financial services products that may not best suit their desires, or that may not make them aware of the full range of alternatives available to them. Often the standardized formats or rate sheets offered by financial institutions require some form of interpretation by an expert in order to ensure that a customer is eligible and that the appropriate pricing “add ons” have been applied. Additionally, there are typically locale-specific fees (based on, for instance, municipality taxes or charges for purchase transactions as to realty within the locale, or other governmental fees or taxes) that, in present mortgage offering systems, may not necessarily be determined simultaneously with the rate/point determination, but rather may require separate researching, calculation, and communication to the customer, thus inhibiting full customer awareness of the “true” total cost of entering into the proposed mortgage transaction, including all ancillary fees—even though this “true” total cost is the most desired piece of information for most potential mortgage customers, and even though customers are often dissatisfied to learn that an estimated total cost for a mortgage transaction does not reflect all the monies they will be required ultimately to provide in order to complete the transaction.

In the area of home mortgage loans, there are two basic types of loans (defined with reference to the secondary market in which loans or portfolios of loans are aggregated and resold to institutional or other investors who wish to purchase loan portfolios). Loans of up to $300,700 (current price; such levels are subject to periodic change) for a first mortgage on a single family residence are deemed “conforming” loans by the Federal National Mortgage Association (“FNMA” or “Fannie Mae”) (a quasi-governmental agency that guarantees certain residential loans and accordingly devises various standards, widely adopted throughout the residential mortgage industry, for generation of and underwriting of home mortgages, in order that the individual mortgages generated may be sufficiently standardized to be aggregated with like loans for resale in the secondary market). Conforming loans are evaluated in the first instance using Fannie Mae's Decision Underwriter risk engine (the risk evaluation process will be discussed in more detail below).

First mortgage loans for single family residences with a cost of greater than $300,700 (current level) are deemed “nonconforming” and cannot generally be evaluated for risk through DU. Instead, they are typically evaluated using other risk engines, for instance the Standard and Poor's “Levels” system.

A typical residential mortgage transaction involves the determination of borrower eligibility for a particular loan product. Loan products differ as to interest rate, points, term, adjustable or fixed-rate nature (or hybrid thereof), and other factors. Eligibility determination comprises two main tasks: evaluating borrower credit characteristics, and evaluating pricing information for particular mortgage products.

Computerized processing of financial services account or transaction information and transmission of information over data networks such as the internet or the World Wide Web (“WWW”) forms an increasingly important segment of commercial and financial services transactions. The advantages provided by conducting banking, sales, purchase, data collection, financial transactions, and transmission of other information whose value is enhanced by the ability to communicate directly and instantaneously between the computer network of a financial services company and the computer or network of that enterprise's customers or counterparts, are evident. In particular, the widespread and increasing availability of home and office computer links to the internet and the WWW has made it possible to conduct, by instantaneous digital means, many financial and other transactions (including loans and cash management functions) that were previously possible only by written correspondence, or by use of dedicated analog communication lines. This capability allows individuals and businesses additional, and potentially profitable, options for communicating and transacting financial services both on a retail-to-customer level and in business-to-business dealings with other companies, vendors, customers, borrowers, or other transnational counterparts. Financial services customers need not create entire purpose-built private networks to ensure communications with each of their transnational counterparts, but rather can avail of the public, worldwide network infrastructure provided by the internet, thus achieving more efficient communication.

The rapid transfer of financial information (e.g., funds transfer authorizations and queries, loan or cash management balance information, loan account status, mortgage payment orders, credit card information, etc.) or other information unique to an individual borrower/customer between that customer and the business hosting the online communication (e.g., a company maintaining a website for financial transactions) over a public network is a particularly advantageous use for internet- or WWW-based data communication systems. There have been numerous applications of this capability within the art. See, e.g., U.S. Pat. No. 5,383,113 (disclosing a system and method for consumer home banking enabling checkless payments to merchants by means of customer-initiated electronic fund transfers); U.S. Pat. No. 5,671,279 (describing electronic commerce system for online credit card payments).

Application of computerized processing and global network connectivity to lending vehicles, e.g., mortgages, has also taken place. For instance, U.S. Pat. No. 5,940,812 claims an apparatus for automatically matching a best available loan to a potential borrower having borrower attributes, via a global telecommunications network, the apparatus comprising: a consumer terminal, operatively coupled to the global telecommunications network, for accepting a first portion of borrower attributes entered by the potential borrower into the consumer terminal; and a server terminal, operatively coupled to the global telecommunications network, the server terminal including: a database for storing the first portion of the borrower attributes sent to the server terminal by the consumer terminal via the global telecommunications network, and for storing a second portion of the borrower attributes provided by a credit bureau, and for storing a respective loan acceptance criteria and respective loan attributes for each loan that is potentially available to the potential borrower; and a data processor for comparing the borrower attributes with each of the respective loan acceptance criteria stored in the database to determine any available loans, and for determining a ranking of best loans among the available loans depending on the respective loan attributes of each available loan, and wherein the server terminal is located with an affiliation of lenders and wherein each of the at least one loan is provided by the affiliation of lenders.

Similarly, U.S. Pat. No. 5,870,721 purports to disclose a method and apparatus for closed-loop, automatic processing of a loan initiation, including completion of the application, underwriting, and transferring funds. The '721 patent sets forth use of a programmed computer to interface with an applicant, obtain the information needed to process the loan, determine whether to approve the loan, and effect electronic fund transfers to the applicant's deposit account and arrange for automatic withdrawals to repay the loan. Information is received from the applicant preferably by using voice recognition technology but alternatively by entering the alpha-numeric information using a personal computer keyboard or using the buttons on a telephone. The loan approval determination is made using a neural network with input obtained in part from the applicant and in part from databases accessed by the computer, such as a credit bureau, to obtain a credit report. The loan agreement is transmitted by facsimile to and from the applicant when the applicant has access to a facsimile machine or data file to be printed or to an agent who delivers the agreement to the applicant when the applicant does not have access. In a preferred embodiment, the applicant accesses the computer from a kiosk where the complete transaction can take place as the applicant waits.

As a result of the diverse forms of lending, cash management, and borrower needs that have developed, each variety or class of lender (or cash management offeror) typically structures and packages its particular product or products in such a fashion as conduces to its own convenience. While the availability of a plurality of various forms of loan or credit products provides some benefit to potential borrowers, borrowers are still forced into the position of shopping for, on a one-by-one basis, multiple different mortgage products, and determining, again on a one-by-one basis, whether they are eligible for each of these products. This scenario is sub-optimal for a number of reasons: customers may be discouraged from evaluating the full range of available products by the labor-intensive nature of shopping for them on a one-by-one basis; customers may not be exposed to the full range of products for which they are potentially eligible; and customers may not recognize that the range of products for which they could be eligible could be expanded or altered by sometimes-slight variations in their specified mortgage types, or by readily-achievable alterations in their personal credit profile (as an example, a customer traditionally might be informed he was ineligible for a given mortgage product on the basis that his credit was inadequate, and might not realize that a slight increase in income, such as he might be able to achieve by virtue of an impending salary increase, could qualify him for many additional categories of mortgages). Thus, inefficiencies are introduced that disserve both mortgage customers and mortgage providers, as the maximal matching of lenders to qualified customers is not achieved and customers are deterred from picking the best product available to their particular financial circumstances.

Additionally, it is generally recognized that there are significant barriers to customer acceptance of new modes of product offering. For instance, many consumers are by nature conservative in product shopping choices and have been found to be initially resistant to purchasing or evaluating products over the internet or WWW when they had been previously accustomed to shopping for such products in person or by other non-online modes, notwithstanding the recognized fact that online provision of goods and services often may provide mutual cost and time efficiencies to both service providers and consumers. As is evident in view of the prior art, networked distribution and processing of financial services data and products is still in an early stage. Global business over the internet or other networks may be regarded as having four phases: a first phase in which electronic information is provided to a consumer (upon request or otherwise); a second phase in which electronic transactions and fulfillment of financial services requests of the customer may be provided by adding increased interactivity to the network; a third phase of full service electronic commerce embracing fully interactive communication between consumer and financial services provider to virtually mimic commercial or financial transactions previously known in the non-electronic milieu; and a fourth phase in which entirely new and unprecedented financial services products are created. As stated, financial services, and specifically the mortgage lending and servicing business, are primarily in the first above-described phase and moving toward the second phase. Few if any “fourth phase” mortgage or financial service products have been developed or delivered to consumers as of yet.

When the online shopping or service-evaluating process is not maximally user friendly, especially during the first or second phase of internet/WWW penetration for a given product or financial service, as in the instance when a potential consumer of mortgage services must engage in multiple, sometimes lengthy, online sessions in order to evaluate the full range of mortgage products for which he may be eligible, or when the customer is not supplied with such full range of products or services because the online mortgage shopping system does not provide intelligent or interactive feedback to maximize the range of potential service offerings, the customer may well decline to engage in future online montage-related transactions. From a standpoint of maximizing utilization and usefulness of online montage provision services, such alienation or under-servicing of customers, especially at the impressionable stage when customers are just being introduced to the concept of online montage provision, is highly undesirable.

Additionally, existing systems for providing information on availability of mortgage products are not believed to apply most efficiently the numerous “business rules” that can be optimally used in evaluating credit and pricing mortgage products. These business rules may be viewed as part of a step-by-step process for evaluating the numerous inputs that determine credit and pricing outcomes. These business rules may often be viewed as a series of questions that may be answered with a yes or no answer, with the answer determining the next step in the evaluation process. For instance, a very simple business rule that might be part of the credit determination would be the question whether the mortgage in question were conforming or nonconforming. Depending on the answer to this question, the business rule would specify a different subsequent series of business rules/questions.

The larger the set of appropriately-selected business rules that can be applied as part of one integrated evaluation process, generally speaking, the more comprehensive and satisfactory will be the presentation of available mortgage products to the customer, and correspondingly, the customer's consideration and assessment thereof. The application of such a set of comprehensive business rules in conjunction with appropriate interactive consultation, which can be used to prompt customer variation of customer-selected input in such a way as to harmonize the customer's input with the business rule (for instance, by “steering” the customer to alter customer-specified parameters in a fashion that will favorably increase or alter the business-rule-dictated array of available mortgage products in order to increase consumer choice), would provide optimal consumer knowledge and customer service, as well as maximizing exposure of lender montage products to potentially-eligible customers and thus increasing utilization of lender products, thus improving lender productivity. However, while certain standard sets of business rules for credit and pricing evaluations in conjunction with consumer mortgage transactions have been known, it is not believed that the prior art contains any comprehensive system for applying a unified set comprising dozens or even hundreds of optimally-selected business rules in a single customer application and evaluation program, implementable online or in conjunction with telephone mortgage sales. Nor is it believed that the provision of effective interactive consultation in conjunction with the automated montage application and evaluation process has been known, such that customers may effectively be prompted or “coached” to input or alter customer-selected data in such a fashion that the range of displayed available mortgage products is optimized or maximized.

Further, synergistic benefits to both financial services providers and financial services consumers could be achieved by integrating into a financial services application, advertising, application, decisionmaking (whether by or on behalf of a product provider, or of a customer therefor, or both—also referred to herein as “decisioning”), and fulfillment product cross-linking and/or cross-marketing capabilities, but such functionality is not currently believed to be delivered in optimal form. For instance, multiple providers of discrete, but complementary, financial services products could benefit from an ability to present their complementary products to a consumer through a one-stop shopping, portal-type offering and decisioning system; as an example, a mortgage lender and a provider of mortgage insurance, or a retirement savings product provider, and a provider of life insurance, could effectively market and present their products to customers, who would likely need both of such complementary financial products if they needed either. However, it is believed that the ability to effectively cross market or “co-brand” such financial products in maximally-effective fashion is not currently realized, in part because known systems for advertising, originating, and delivering such discrete financial services products do not provide optimal decision rule sets for providing the most appropriate mixture of complementary products to a particular customer, or for providing consultative feedback to the customer and adjusting automatically the offered range of financial services products, in such fashion as would allow both the customer and the providers to benefit from the most individualized product information and product mix being appropriately presented and delivered to a customer based on his particular needs, qualifications, and interactive feedback choices during the application/evaluation/fulfillment process.

Accordingly, the financial services market for individual consumer mortgage borrowing may be regarded as highly inefficient from a customer's (borrower's) perspective as well as that of the provider (mortgage lender). There is a need for a customer montage loan application system and method that is: (a) highly interactive with respect to consultation and customer feedback, allowing customer tailoring or loan and credit parameters to maximize customer exposure to mortgage loan products for which the customer is eligible; (b) adaptable to the broadest range of consumer lending products (including variants on standard home mortgage products); (c) capable of applying effectively and in integrated fashion a comprehensive set of business rules adapted for presentation of a maximal range of potential mortgage products; (d) adapted to function effectively for the broadest range of potential mortgage borrowers as well as the broadest range of mortgage lenders; (e) compatible with mortgage industry standards (for instance, standards for credit evaluation set forth by Fannie Mae or other mortgage-guarantee entities, and compatible with the standards for the secondary market in mortgages); (f) adapted to allow the customer (potential borrower) globally-accessible interfacing with such method and system which resides, for instance, on a web server and is accessible by a client computer connected thereto over a public data network such as the internet; (f) in secured form such that sensitive customer financial data is not exposed to inappropriate interception or scrutiny; (g) adaptable for use with cross-marketing and co-branding by a plurality of financial services providers or other entities who may usefully collaborate in the presentation of consultatively-adjusted financial services product information to a customer, whose range of possible financial service combinations is thus further enhanced and individuated; and (h) usable over a broad range of computer platforms (on the part of the mortgage provider as well as the prospective borrower). The prior art does not adequately meet these needs.

### SUMMARY OF THE INVENTION

The invention herein disclosed is a method and system for supplying and managing a financial services product application and evaluation system and method that provides interactive consultation and customer feedback, allowing customer adjustment of parameters relative to a particular financial services product or group of products to maximize customer exposure to the fullest possible range of financial services products for which the customer is eligible. The disclosed invention is intended to be implemented in conjunction with any generic financial services products. In one presently-preferred embodiment, described in detail herein, the financial services products offered to the client through the consultative decisioning system includes consumer lending products (including conventional fixed rate and adjustable rate mortgages as well as variants on such standard home mortgage products). The present invention applies a broad set of business rules for guiding the application and evaluation process (in conjunction with the customer-adjusted inputs prompted by the consultative features of the invention) in order to streamline and optimize the evaluation and presentation of financial services product parameters and available financial services products, or sets of products. In the illustrative case in which the financial service product includes a consumer lending product such as a home mortgage, these product parameters would include, for example, credit and loan parameters.

Accordingly, the present invention offers the capability of functioning effectively for a wide range of potential financial services consumers as well as financial services product providers (in the example of a mortgage financial product, i.e., the system allows effective functioning for a variety of types of borrowers as well as a wide range of mortgage lenders). Because the preferred embodiments of this invention contemplate a financial services product that includes a consumer credit product such as a home mortgage, and because the system can be configured for utilization of standard credit evaluation engines such as Fannie Mae's Desktop Underwriter (in conjunction with other appropriate credit evaluation systems), the present invention is compatible with financial services/mortgage industry standards and can be used in conjunction with origination of mortgages that will be readily amenable to repackaging and resale in the secondary mortgage market. It will be evident that for other types of financial services products, similar inclusion of industry-standard evaluative, regulatory, or other rule sets may be incorporated into the business rules used for decisioning, such that the financial service product or group of products offered to (and potentially entered into by) the consumer conform with any applicable legal, market-driven, or regulatory regime of parameters desirable or necessary for the particular financial services product or group of products.

Further, the present invention is compatible with a wide range of computerized implementations, in particular with systems in which potential financial services customers (e.g., mortgage borrowers) initiate financial services (e.g., mortgage) evaluation or application services over the internet or WWW (or in conjunction with telephone call centers in which telephone operators perform computerized input of customer-supplied information) so that global and round-the-clock real-time access to mortgage application and evaluation services is made possible in appropriately-secured form. However, the present invention is not limited to those illustrative means of access. As will be recognized, in the instances in which direct computer links such as the internet are used for delivery of the present invention's system, once the customer has input, for instance, credit and product details (varying them as desirable under consultative prompting from the system), and has viewed the range of available financial services products, the customer can elect to take the next steps in having his financial services product application or applications processed, again in a convenient online fashion, thus further expediting the financial services application, approval, and origination process, saving time, and providing accurate information to the customer on all involved costs and fees, as well as potentially providing substantial savings to the financial services provider or providers by replacing labor-intensive human operator consultation and processing services with speedy, accurate, and cost-efficient automated processing of these front-end portions of the financial services origination process.

Current financial services products offer limited value in terms of: (a) functionality allowing customization of, e.g., mortgage loan structure, terms, etc.; (b) flexibility to change the nature, terms, or amount of the financial service product or suite of products to serve the customer as his needs evolve over time or his financial posture changes; and (c) integration with other credit and cash management products.

To take one example as to flexibility, a given financial services consumer will not have the same credit profile, financial needs, or investment goals over his lifetime; rather these needs will evolve significantly. A married couple at the time they are just finishing school and purchasing a new house at the outset of their careers has very different financial needs from the same couple fifteen years later when they are established in their careers and considering funding for their children's college education, or fifteen years beyond that when they may be considering paying off their home mortgage and retiring from their jobs. Yet if this couple initially finances their house with a conventional thirty-year home mortgage, the terms of this mortgage obligation (e.g., interest rate, payment schedule) will generally not fit their evolving financial needs equally well at all times, nor will it necessarily harmonize with their other financial strategies, investment products, or credit relationships.

Some attempts have been made to address known shortcomings in the lending market. For instance, adjustable rate mortgages (ARMs) have been known for some time, and permit a home buyer, for example, to obtain a mortgage whose interest rate may vary within certain ranges over time, rather than remaining a fixed rate for the entire life of the mortgage loan. However, ARMs fall short of solving each of the above-identified shortcomings in known finance/loan products. For instance, the ability to customize an ARM is limited, and the ARM obligation typically is managed completely apart from most or all of the borrower's other loans or financial obligations/cash management needs.

As previously noted, it would thus be desirable to provide a method and system for supplying and managing a ubiquitous financial services account integrating management and transnational functions for multiple accounts of a customer, and allowing said customer globally-accessible interfacing with such method and system which resides, for instance, on a web server and is accessible by a client computer connected thereto over a public data network such as the internet. It would further be desirable for the integrated accounts collected within such ubiquitous account to include a mortgage or other loan account of the customer/borrower. It would also be desirable for the customer/borrower to be able continuously over time to alter the nature and structure of his mortgage obligation terms in appropriate fashion to respond to his individualized financial needs as they evolve over time. It would likewise be desirable for the financial services account to include a cash management account whereby a customer could manage investments, cash or cash equivalents, or make bill payments within the same integrated account. It would further be desirable to be able to provide such an account in secured form such that sensitive customer financial data is not exposed to inappropriate interception or scrutiny. The prior art, once again, does not meet these needs.

Consider an example in which a financial services customer may enjoy globally-accessible interfacing with such method and system which resides, for instance, on a web server and is accessible by a client computer connected thereto over a public data network such as the internet. The various embodiments of the present invention will allow for customization of account features, periodic updating of account information and loan obligation terms by varying of customer-selectable parameters, secured delivery of transnational information over the network for the customer's ubiquitous account, and a seamless system for most or all of the customer's financial needs throughout the various and disparate phases of his financial career.

By using the present invention, financial services consumers can drive the creation and structuring of the financial service products that they consume, rather than simply accepting loans or other financial relationships on fixed terms dictated by financial services providers. By providing the power for consolidating all or most financial needs or products for a customer into a single account, the present invention provides economies of scale that allow the customer to demand, and the service provider to supply, more favorable terms than would likely be available if the consumer had entered into a plurality of financial relationships of smaller magnitude with an unrelated group of financial service providers.

### DETAILED DESCRIPTION OF THE PREFERRED EMBODIMENTS

Note that, for purposes of illustration, certain embodiments described herein are set forth in connection with: (a) an exemplary case in which the financial services product handled by the present invention includes (but is not limited to) a consumer home mortgage loan; and (b) use by the financial services customer of a personal computer system or workstation (comprising a computer processor such as an Intel Pentium processor, and implementing a communications module such as a common web browser such as Internet Explorer or Netscape), linked by a WWW connection to a financial services provider website, or any host website where one or more financial services products may be presented within a desired rubric, for gaining access to the consultative decisioning functions of the present invention. It should be understood, however, that the financial services products, or combinations of products, amenable to use with the present invention are not limited simply to consumer mortgage products, or even to loan products more generally, but may include a wide range of financial services products and groupings thereof (for instance, savings products, insurance products, specialized loan products, retirement accounts, commercial mortgage products, etc.). Further, access to the system of the present invention may take place through a variety of avenues or devices.

For instance, the “client computer system” as set forth and claimed herein in conjunction with the method of this invention may be any apparatus comprising a processor and communications module capable of receiving, transmitting, and displaying customer and provider requests and responses for account or transaction data, the system being used for data transmission with a server wherein the information regarding the customer's ubiquitous financial services account resides. Such client computer systems may include processors that are elements of, for example, cellular phone systems, cable television decoders, automatic teller terminals, and the like. It must also be understood that the present invention would embrace any implementation of a consultative decisionmaking-capable financial services account offering, application, provision, and management method, even if such implementation took place other than by computerized means.

In the illustrative embodiment in which access takes place through a consumer link from a consumer personal computer through an internet connection to a web server hosting information regarding the financial services product(s) handled by the present invention, the web server has (as constituents of its memory) an unsecured area and a secured area containing protected information belonging to either the web server provider or to various of its customers. Web server has a memory computer processor, and contains a suite of home accounts ((12a), (12b), (12c), etc.) each representing the ubiquitous integrated financial services account of one of a plurality of customers. Web server processor may also be linked to main financial service provider server(s) remote from web server such that web server processor has full or partial access to account information archived or stored in master form on main server(s).

Data communication line connects the financial services provider web server computer with the client or end user computer. Client computer comprises a memory and computer processor as well as web browser, which operates in conjunction with both memory and processor.

Application of the invention begins when client computer initiates a communication session with web server by sending a session start request over data communications line, which is, for instance, an arbitrarily-determined WWW connection passing through multiple nodes of the internet. Line may initially be provided with some level of encryption (perhaps a relatively weak level such as 56 bit encryption), supplied for instance by an encryption module contained in encryption module area of client web browser. Alternatively, either client web browser) or web server may impose or require desired high-level encryption, for instance 128 bit, 448 bit, or other encryption under SSL (Secure Socket Layer) or 3DES encryption protocols or other encryption protocol known in the art for maintaining the secrecy of a transmission of highly sensitive financial data over a public network.

Once account is set up for a new client, the client may proceed to customize his account as set forth more fully below for any normal transaction for a customer having an account.

As to the session initiation procedure for existing customers, such existing customers' computers, either automatically or upon prompting, will transmit appropriate identification and login data (e.g., a password or Personal Identification Number (PIN)) whereupon web server processor will recognize the customer and will retrieve the identifying and other information for the appropriate customer home account. It will be understood by those of ordinary skill that web server processor (16) is a parallel processor with access to memory and processing capacity sufficient to mediate a plurality of sessions with a plurality of different client computers (i.e., different customers), transacting business in respect of numerous accounts) simultaneously. Such transactions may require supplying data to, requesting data from, or initiating financial transactions with, third party servers external to the financial services company web server or main server—e.g., the server of a brokerage or third party financial product vendor from which it is desired to purchase a securities position, etc. In such an instance web server and/or main server are connected to third-party server by appropriately-protected data line (e.g., an encrypted internet connection).

There may be considered an exemplary flowchart for the process of customer login (and new account setup, if necessary), session initiation, and transaction of business with home account. The first step represents the initiation of the communications session. The next step represents determination of whether the customer is a new or returning customer. The following step represents a subroutine for setting up a new account if the customer is a new customer. Yet the next step represents the presentation (e.g., by transmission over data line for display through client web browser of home account data to a verified customer. This data may include account identifier number, financial totals for various financial services products evaluated by customer, payment due dates, amortization schedules, cumulative data regarding account performance, etc. In a following step, the customer is prompted or permitted to request a variety of account information or account transactions. Subroutines (224a), (224b), etc. may include additional sub-subroutines, e.g., allowing a customer to preview the effect of a variety of contemplated account relationship changes (e.g., altering both the term and interest rate of a mortgage loan within parameters permitted by the financial services provider) before actually executing such changes. This step relates to the consultative feedback feature of the present invention. In other words, these sub-subroutines may function as a mortgage calculator, etc. to allow the customer to decide which of a panoply of home account changes will best serve his particular investment objectives.

In a final step, the customer, having previewed and selected each of the desired transactions or account relationship changes, sends a final execution command through his computer to the web server, authorizing and requiring the implementation of the changes selected by customer. In a concomitant step, the web server(calling if needed on data from the web server processor and/or memory), processes the client's requests, including determining whether the requested data or transactions are ones that can, under the terms of financial services provider's business strategy or formula, e.g., its various sets of first, second, and third business rules, comprising margin requirements, etc., be supplied to customer. If it is determined that the customer requests are all suitable and executable, web server causes them to be so executed in step (if some or all of such customer requests are not suitable or executable, the customer is prompted to revise such nonconforming requests through step again).

The final step includes display of a transaction confirmation or requested information through the customer's web browser.

It may be useful to set forth an exemplary description of the application of the system in connection with a particular financial services product, i.e., a consumer mortgage loan, and a particular illustrative set of business rule; it being clearly understood that the utility of the present invention resides in part in the ability to adapt it to a range of other financial services products, and that business rule sets may be arbitrarily defined (and regularly altered or updated) as is most appropriate for a particular financial services product or group of products. In the following mortgage-based example, certain terms particular to the mortgage industry are set forth, as will be readily apparent to those familiar with the industry. A representative glossary of mortgage industry terminology may be found at the website for www.approvalfinder.com, located at internet address http://www.approvalfinder.com/glossary.html.

### EXAMPLE

The decision engine for a consumer mortgage financial product may also support global rate or point adjustments based on business line. For example, the mortgage provider could lower all base rates or all relocation rates by ¼ point to stimulate business. Additional enhancements could include the ability to use information in the “client” database to display to distinct customers pricing that is completely tailored to their needs. This functionality may be deemed a priority as special relationships with particular third parties (for co-branding purposes) clients are entered into by the mortgage provider.

Adjustments. The decision engine can support pricing adjustments (rates and points) for the same attributes as determine eligibility. The mortgage provider need not necessarily provide pricing adjustments for every attribute in a basic implementation, but they could be supported as desired. These economic adjustments to base pricing are all termed “Tier 1” adjustments.

“Tier 2”, or marketing adjustments are those concessions made for a specific business partner of a financial services provider (e.g., relocation-of-corporate employee or co-brand partners of a mortgage provider). No “Tier 2” adjustments need be supported in a basic implementation of the present invention. Alternatively, any “client-specific pricing adjustments” (for example, IBM Relocation) could be handled manually by a human operator in a Wave 1-only implementation, or they could be loaded as separate products with rate/point differences handled in the daily upload, which can be accomplished on a limited basis.

Closing Costs. The present method and system contemplates a “fees engine” to deliver fees which show up as HUD-01 line items for closing costs. The method's fee structure has been simplified for Wave 1 purposes. The fees currently are flat fees or only vary by property state, loan amount or purchase price, note rate (interim interest), number of borrowers, or escrow/cushion period. However, provider-selectable exception handling needs can also be included (for example, state-specific adjustments to the type of financial service/mortgage products allowable under various states' laws and regulations).

In the most basic embodiment, there need be no support for fee adjustments or overrides at any level (global, business channel, waivers, etc.).

Rate /Pricing Upload. The capital market's group of the originating bank for the financial transactions may develop a spreadsheet with rates and points by product. This is converted into a text file and imported into the system as needed, typically on a daily basis (for example). The system will support an upload of the same source information into the credit-related database. The user interface may be a simple command-line interface or a simple Java graphical user-interface.

As indicated, the provider is responsible for, and aware of, each of the customer's various loan obligations, assets, etc. Increased financial leverage is provided to consumers because they can control and customize debt structures. Unlike in conventional mortgages, wherein the mortgaged realty is not replaceable as the collateral for the loan, the present invention will permit a mortgage to be obtained, or maintained, without necessarily keeping the exact same realty as collateral through the life of the loan, as long as the customer's overall financial portfolio of assets and liabilities, as managed on an integrated basis by the account of the present invention, presents adequate security for the lender/financial services provider. The present invention also allows for maximally-efficient bill/payment administration and personalized “one stop shopping” for financial services on both the asset and liability side of a customer's investment profile.

The customer account may include a variety of financial service products, etc. (as custom-configured by the customer within acceptable financial service provider-defined parameter ranges (e.g., a range of possible interest rates, repayment periods, etc.)). The number and variety of products may vary from customer to customer, although in the preferred embodiment the account will include at least a residential mortgage loan as one component. For purposes of this invention, it is not of great significance whether financial service products, etc. are, respectively, first mortgages or other financial obligations or assets of the customer. The system (e.g., the web server processor) is programmed to calculate net customer financial position by summing and analyzing financial data for all financial service products.

Thus, for instance, the customer may be presented with, and may usefully evaluate, a suite of potential financial services product categories for which he is eligible (e.g., mortgages, retirement investment accounts, insurance policies), and within each category may also evaluate and refine (in consultative fashion) his choices among a variety of possible products within that category, such that an optimal suite of products may be evaluated. The customer may then choose to apply for, enter into, and manage on an ongoing basis one or more of the offered/eligible products within one or more of the categories. The customer's suite or portfolio of actually-acquired financial services products may be updated on an instantaneous and ongoing basis. Additionally, the customer may complete a partial evaluation or application/acquisition of a financial services product or suite of products, but not complete such transactions for all the products for which he is eligible or which he ultimately desires; the system may be configured to store (e.g., in computer memory of a system web server computer) the choices and evaluations made by the customer so that the customer may resume his evaluation/application/acquisition process at a desired later date. For instance, a customer could initiate evaluation of a range of mortgage, retirement investment, and insurance products on a given day, but might only complete the application and consultative decisioning process for the mortgage product. As part of the ongoing account functionality of the system, the system may be configured so that when the customer next gains access to the system, even some days or weeks later, he may resume his consideration of, and application/acquisition of, the same set of eligible retirement and insurance products he had not previously finished evaluating.

Other benefits of the present invention include the fact that it may be made “life stage responsive” as to customers' evolving needs. As discussed before, any customer's mortgage, credit, bill payment, and investment needs evolve over the course of their lives such that different financial products will assume different significance at various stages of the customers' relationship with the financial services provider. It is in the interest of the financial services provider as well as the customer to maximize the responsiveness and ease of changing the account to take such evolving needs into account. For instance, as a customer grows more creditworthy (based on his assets within account, which are automatically monitored by the financial services provider) as he advances in his career, the provider may be willing to extend credit to him on more favorable terms, even as to obligations originally incurred as long-term, fixed rate loans (for instance, a mortgage). Under the present invention, such adjustments in the terms of the obligation may be made with relative ease (in accordance with algorithms or approval routines implemented from time to time by the financial services provider), in a much easier fashion (and with less paperwork) than would be required through, for example, a formal refinancing as it is practiced today. Additionally, because the present invention contemplates consultative decisionmaking and feedback, the customer, based on his input to the system during various sessions, may be prompted by the system when it appears, based on the business rules, that the customer's eligibility for particular financial services products has changed, or that a more advantageous combination of financial services products than the one currently contained in the customer's portfolio, may be available to the customer. The consultative feedback allowing such prompting may be elicited, for instance, by requesting a customer to enter new credit-related information when he initiates new sessions relative to his account, or by periodically requesting from the customer either updated data, or projections as to future financial parameters (e.g., projected future salary, retirement plans, anticipated career changes, plans for moving primary residence or relocating to a different geographical locale) so that the system may provide predictive or forward-looking consultation as to a more advantageous mixture of financial services products for which the customer is currently eligible and may desire, or for which the customer can be expected to become eligible in the future based on his inputs/predictions as to anticipated changes in financial or life status.

The advantages of the above-described flexible financial service product structure are obtainable in part because the present invention allows constant reassessment of the value of the assets and liabilities pertaining to the particular customer, across a range of financial services products, or even within a single product. For example, when the financial services product or product range includes a secured consumer credit transaction (for instance, a home mortgage), there will generally be collateral (e.g., the real property) associated with an account. Because the value of the real property on the market will vary from time to time, the system can be updated on a periodic basis to reflect such valuation changes, such that fine adjustments can be made to a credit relationship quickly when events so warrant. E.g., if the value of the collateral securing a mortgage product increases substantially, this information may be supplied to the system, such that future customer evaluations of other financial services products (e.g., additional credit transactions, or retirement savings, or homeowner's insurance) may be intelligently made, using the responsive feedback provided by the system's “knowledge” of the increased collateral, to make the best choices taking into account, for instance, the increase to the customer's credit capacity that may result from the increased value of his equity in the collateral, or the possible need for a larger homeowner's insurance policy to reflect the substantially increased value of the home. In past systems, the ability to provide such updated and responsive advice or options as to related (or even unrelated) financial transactions based on variations in the evolving status of the customer, or of a first financial services product previously obtained by him, was not necessarily readily available.

Additional, more flexible financial service product forms and combinations are also obtainable by using the instant invention. For instance, in the realm of consumer loan products, a debt can be optionally presented for evaluation, application, and acquisition in alternative forms: e.g., a debt structured with a pure fixed interest rate, a pure floating rate, or with a combination of first fixed rate (having a first term of years) applicable to part of the principal, a second fixed rate (having a different term of years) applicable to another portion of the principal, and a floating rate applicable to the final portion of the principal. The various proportions could, if the lender were amenable, be varied easily at customer request from time to time, to provide a broad spectrum of loan products within a single account relationship.

As another example, a customer's credit card interest rate could be incrementally lowered if his credit card were linked within account (12a) to an increased cash management position also managed by provider within account (12a). This information can be provided to the customer in consultative feedback during his initial session evaluating or applying for either the credit card account or cash management account through the present invention's system, or could be presented to him as consultative feedback in future sessions, depending on when the provider or providers of the respective financial services products chose to make such discount available, or when the customer first reached certain creditworthiness or other eligibility determinations that the system may be programmed to elicit, evaluate, and consultatively respond to on an ongoing basis for particular incentives or particular crosslinking of discrete financial services products within the offering, evaluation, or portfolio management context.

Accordingly, there is substantial value for provider as well as consumer in the present invention, as it is seen that provider may offer (either at the outset of a financial services product evaluation/application process, or during that process through consultative feedback responsive to customer-entered data and preferences, or on an ongoing basis once the customer's account portfolio is set up with at least one financial services product) various favorable modifications to the terms of various financial service products, etc. as an incentive to secure desired investments, transactions, or other actions by the customer that will provide favorable fees or asset inflow, etc. for provider. Provider also secures long-term customer loyalty of the customer, for the maximal customer advantages under the present invention will be obtained when the customer places or adopts as many of his overall financial products within account and keeps them there for a long period, such that provider (thus having comprehensive knowledge of customer's financial positions and credit history, as well as the profit incentive (e.g., for account service fees, finance charges) provided by a larger aggregate customer sum involved in the account may confidently provide customer with additional incentives and favorable terms for various financial service products, etc. within his account.

In this connection, the adaptability of the present invention for cross-marketing and co-branding of related or unrelated financial services products should be evident to those of ordinary skill in the financial services industry. While certain embodiments described hereinabove have contemplated that a single financial services provider would be the source for all the potential financial services products and categories of products among which a consumer could conduct evaluation, application, acquisition, and portfolio management, and that that financial services provider would also serve as the provider of the decisioning and consultative feedback functions for all such financial services products, e.g., by hosting the evaluation/application/acquisition/portfolio management functions, as well as feedback and decisionmaking, from its own web servers, this is only one potential scenario allowed by the present invention. Alternatively, a plurality of different financial services providers could be used, each for a separate category of financial services product, and even within a particular product category, the customer could be presented with evaluation/application/eligibility opportunities from among a plurality of providers for that category of product. From the customer's point of view, the shopping/application process could be made an integrated “one stop” shopping experience, even while he is enabled to evaluate multiple products from multiple providers, and even while those providers may in turn be supplied with information relative to the customer (thus saving time and conducing to customer convenience, as the customer is only required to enter certain personal/identification/credit/eligibility-related data once to the system, which then sends such data or subsets thereof to individual financial services providers as required).

This functionality represents a useful form of cross-marketing, wherein providers of mutually-compatible financial services products may present them in convenient bundled form to a potential customer. Increasing the advantages of such cross-marketing is the consultative feedback provided by the present invention, whereby the system can determine that a customer who has requested or evaluated a first category of financial services product (for instance, a home mortgage) may be eligible for and may desire a second, complementary product (for instance, mortgage insurance or homeowner's insurance). Similar cross-marketing opportunities may be readily envisioned, for instance among mortgage products and home equity line of credit products, or among retirement savings products and life insurance or annuity/estate planning products. Again, the system having acquired and analyzed customer data and preferences in connection with a first financial services product, it may effectively analyze, and interactively provide suggestions on, customer eligibility, or possible desire for, a second complementary product, all the while taking into account the aggregate financial posture that would result from various combinations of products.

For instance, once the system has evaluated or offered (or executed) an application for a home mortgage product, it will be aware of the customer's projected monthly mortgage payments vis à vis the customer's other credit parameters. It could then proceed to suggest appropriate retirement investment products based on the remaining portion of the customer's projected income, and taking into account the fact that the customer's equity in the purchased home, and capital appreciation thereupon, can be taken into account as part of the customer's retirement assets (such analysis could be even further refined, e.g., if the system queried the customer as to whether he currently planned to bequeath the home to his heirs upon death, or alternatively to sell the home at retirement age and move to rental housing). Thus, the customer may be taken through a panoply of potential scenarios for retirement savings products, each taking into account, and at each step providing consultative feedback based upon, the changes in his financial posture relating to his initial home mortgage product acquisition (and any subsequent product evaluations or acquisitions, as well as any subsequent changes in personal financial status or prospects). The ability to manage and update such a portfolio of financial services products, and to provide ongoing consultative feedback, combines the general advantages of consultative feedback for financial service product evaluation and acquisition with the specific advantages of an ubiquitous financial services account. Obviously, in connection with either the consultative feedback and prompting functions of the present invention, or the embodiment in which these are incorporated with a ubiquitous financial services account, the advantages of the present invention can be realized to a greater and greater extent as more customer-specific data are generated or prompted to be entered.

For instance, as noted before, although future earning streams may not be a parameter for certain basic creditworthiness evaluations (because, inter alia, they are somewhat speculative), if the customer can estimate future substantial changes (increase or decrease) in projected income, the system may take these projected changes into account in suggesting various options for financial services products currently being contemplated (e.g., by suggesting products having a lower, or higher, monthly cost, based on the customer's projected changes in ability to pay). Similarly, eliciting family information about the customer can likewise enhance the offerings that can be made to him; e.g., by inquiring as to the age and number of the customer's children, if any, the system can evaluate whether and when it would be appropriate to present automatically to the customer information regarding student loan financial products or college savings plan financial products in connection with the child or children's higher education. The decision as to how much personal and financial data the system should prompt a customer for, and the decision trees based upon which a subsequent question may be tailored based on the customer's request to the previous question, will be largely dependent on the business judgment of the financial service product provider or the supplier of the decisioning/feedback system, who will be best suited to balance (a) the benefits of obtaining maximal customer information to tailor consultative feedback and customized product offerings to the customer against (b) the risks of burdening the customer with excessively time-consuming or intrusive questioning.

However, such risks can be minimized with the present invention, because (1) the consultative nature of the questioning, and appropriate structuring of decision trees, can ensure that customers are asked increasingly focused and relevant questions, and not simply boilerplate questionnaires, based upon their previous responses; and (2) the ability to supply much of the personal and financial data one time only, and subsequently have such data automatically applied in connection with multiple evaluations of and applications for a plurality of financial services products across a number of categories thereof should represent added convenience value encouraging the customer to invest the comparatively-small amount of time needed to supply initial personal and financial/credit information and to update or supplement it only when the system's business rules indicate that such supplementation may further enhance the offerings or portfolio management services that may be supplied to the customer.

Additionally, it is not necessary that the financial services product providers also be the providers of the system and method of the present invention. That is, the gathering together of various available financial service products and categories of products, the initiation of sessions with customers, the acquisition of basic customer data and preferences, and the supplying of consultative feedback and prompting based upon such customer data and preferences, thus allowing presentation of a range of potential product categories and products, may be supplied by one or more of the financial service product providers, but it may certainly also be supplied by a third party or parties who is/are not among the providers of products or product categories but rather undertakes only the value-enhancing step of providing one-stop access, with consultative feedback, to gather disparate financial services products under a single umbrella with integrated counseling to the customer.

Those familiar with distributed computing functions will understand that it is irrelevant to the customer whether the range of financial services products he is evaluating, applying for, obtaining, and managing, is in fact provided by the same company or companies supplying the consultative feedback and portal functions for the evaluation/application process, or whether a single provider or a large plurality of providers is the source of the products for which the system notifies him he may be eligible and which he may advantageously wish to consider. Rather, the customer need only be aware that a single system (along with a single session in which he inputs basic financial and other data for storage and automated use in subsequent transactions) allows him access to interactive application, comparison, and management functionality for a host of financial services products potentially covering most or all of his financial needs, e.g., credit, debt, etc.

Other forms of co-branding are possible with the present invention, apart from simple cross marketing. For instance, certain customers may be granted access to preferential treatment (e.g., superior interest rates, reduced ancillary fees, and other special programs) based upon their status (e.g., their relationship with another party or entity) as supplied by them to the system.

To take one example, a corporate employer may wish to ease the job-required relocations of its employees by subsidizing or creating special programs for the moving employees' sales of old houses and/or acquisition of a new house and mortgage. In such a relocation (“relo”) scenario, the employer or other sponsor might, for instance, subsidize certain costs associated with the mortgage application and closing process, or might negotiate with a mortgage lender to give the employer's employees reduced interest rates in exchange for referring all relo employees to the lender.

In this connection, the system may readily be configured to elicit from the customer identifying data, e.g., the name of his employer or a program number for any special relo program, during the evaluation or application process. The system would then determine whether the customer was entitled to any “relationship-based” incentives, and would provide feedback to the customer notifying him not only of his eligibility for such incentives, but factoring in the applicable discounts in the exemplary rates, payments, and other parameters displayed to the customer in connection with mortgages for which he is eligible. Such “relationship pricing” provides numerous opportunities for enhancement of marketing for both the financial service provider and (if a third party maintains the decisioning/consultative feedback system), third parties. For instance, the system could readily display to the customer the relationship-based pricing data side-by-side with the standard pricing, thus making quite clear to the customer the advantage of choosing the relationship-based price from the product provider who has established the relationship with the customer's employer. Other “relationship-” based interactivity features will readily suggest themselves; for instance, a customer could have applied to him certain advantageous relationship-based business rules based on having been referred by a previous customer of the financial services provider, or having been directed to the system (in an internet-based embodiment) by a referrer page of an entity having a preferential or joint venture business relationship with the business operating the decisioning/consultative feedback system or with the financial service product provider.

Obviously numerous potential relationship-based pricing or credit or eligibility adjustment factors may be built into the business rule sets and applied, in combination or alone, to enhance the flexibility and commercial attractiveness of the system to customers and financial services providers alike. It is not believed that the prior art teaches or suggests automatic, and customizable, adjustment of offering/evaluation/application/fulfillment functions for financial services products based upon customer input qualifying the customer for special relationship-based business rules or other incentives, such that the customer's “payoff” for a particular relationship is automatically presented and delivered to him, and the relationship party whose relationship with the customer justifies such preferential treatment gains maximal effect from the investment, co-branding, or other arrangement under which it provided for its related customers to receive preferential treatment through the system disclosed and claimed herein.

Broadly, then, the present invention supplies a custom-configurable system and method allowing a customer or potential customer for at least one financial services product: (1) to be presented with information relative to that product; (2) to evaluate such information; (3) to supply information regarding himself, his financial and credit status, and/or other personal data or financial goals; (4) to have such data evaluated both (a) as part of an application/eligibility/credit/pricing decision process (determining whether he is eligible for one or more potential products within the product category he has indicated an interest in, and if so, the various structures and features of the product(s) for which he qualifies); and (b) in connection with consultative feedback from the system (which may or may not comprise feedback from the provider(s) of the product(s) in question); (5) to execute an application for one or more financial services product (and to have application information stored for future convenient use); (6) to obtain accurate pricing data in connection with the product for which application is or may be made; (7) to obtain confirmation of approval of his application; (8) to have the financial services product maintained as a constituent of a permanent account with the provider of the instant system; (9) to make updates or changes to the account status, whether by (a) altering terms of extant financial services products within the account in certain fashions desired by him and permitted by the provider, or by (b) evaluating, applying for, and initiating additional financial services products, and (c) obtaining consultative feedback in connection with the ongoing management and updating or contemplated updating of the account; (10) at multiple stages of an evaluation, application, or management, allowing (or prompting) the customer to change his earlier inputs and/or assumptions and so change the range of products that he may evaluate; and (11) providing co-branding, cross-marketing, and other synergistic commercial functionality to providers of financial services products whose products are evaluated and/or purchased through the system, and enhancing customer options thereby.

The business-rule-set-based consultative feedback functionality of the present invention may be viewed as a form of artificial intelligence. Generic rule-set-based expert systems have existed, but have not provided or suggested all the advantages of the present invention for optimal evaluation of, application for, fulfillment of, and management/variation of, one or more financial services products within an account or portfolio. See generally, e.g., U.S. Pat. No. 5,784,539; see also U.S. Pat. No. 6,112,181. Business rules may generically be viewed as logic statements directing a subsequent processing or action step; i.e., “if . . . then” statements, whereby a condition or conditions, alone or in combination, is used to actuate a subsequent data manipulation, output, algorithm step, or a particular fork in a process flow or decision tree.

The business rules used in connection with the present invention may be divided into sets. The use of a plurality of sets of business rules can provide added functionality for particular embodiments or particular financial services products or combinations thereof, but it should be understood that no particular number of business rule sets, nor any particular grouping or definition of business rules within such set(s), is a sine qua non or limitation of this invention, as business rule definition and set definition may be customized to meet customer, provider, and product-specific needs.

As an example, a first set of business rules may relate to eligibility—e.g., a “first cut” definition of the range of products, based upon basic customer, property, and transaction characteristics, for which a given customer, in connection with a given proposed transaction, is potentially eligible. For instance, in the case in which the financial services product comprises a consumer mortgage, the first set of business rules could comprise rules evaluating interrelationships among attributes such as loan amount, state in which the property is situated, owner-occupancy (e.g., single family vs. multiple family dwelling), etc. Using as few as twelve (12) such basic customer, property, and loan attributes, it is possible to define up to twenty-five hundred business rules in a first business rule set for the consumer mortgage example. For instance, a given business rule could direct the system to take a specified action, or display a specified consultative prompt or error message to the customer, based upon the fact that the loan amount entered was very high vis a vis the occupancy status of the property. Obviously, the determination of what combination of attributes will prompt what display, output, error message, or consultative prompt, will depend in part on financial service product provider-defined rules for eligibility based on the multiple permutations of the initial data attributes used in the first set of business rules, with the system evaluating said first data using a first set of business rules to determine a first range of available transactions meeting said customer-desired characteristics.

Continuing for illustrative purposes with the consumer mortgage embodiment, a second set of business rules could be defined under the broad heading of credit-related business rules. This second set of business rules may be viewed in aggregate as a risk engine (just as the aggregate application of all the business rules, over whatever plurality of sets, can be viewed as a financial product transaction decisioning engine). For purposes of convenience, and for purposes of developing financial products conforming with industry standards, business rules or sets thereof can be adopted to comprise industry-standard financial parameters. For instance, the second set of (credit-related) business rules for the mortgage embodiment may comprise creditworthiness rules promulgated by the FNMA's Fannie Mae DesktopUnderwriter system (or, for non-conforming loans, the S&P Levels underwriting standards). These industry standard credit evaluating programs determine, based on a customer's individual financial data inputs (as well as property inputs) whether a customer is eligible for a loan for a particular principal value, down payment, credit rate, points, etc. An advantage of including such industry standard sets of decision rules as part or all of the credit decision rule set is that mortgage products generated thereby will conform with industry standards for resale (e.g., in pooled mortgage backed securities) in the secondary mortgage markets. Thus, the business rule set relating to credit can comprise rules based on, e.g., consumer credit history, income levels, etc., and combinations of such parameters. Additional business rules may be added to the bundle provided by the DU or Levels systems; for instance, business rules could be added to determine that if an applicant could not qualify for a particular credit level using DU, his application should automatically be evaluated by the Levels system. Consultative feedback rules can also be advantageously incorporated in the second set of business rules; e.g., if the risk engines indicate that a particular customer does not qualify for a particular mortgage amount or product, a rule could direct the system to ask the customer whether he could provide a co-signer whose income and credit could be taken into account in the risk engine; or whether he expected to receive an increase in salary in the near future; in either of which cases, the customer could thus be prompted to enter new information which, when analyzed again by the risk engine, might indicate a more favorable potential credit profile and additional credit options for the customer.

Continuing further with the mortgage loan example, a third set of business rules can be defined and applied, this set being drawn principally to supplying the customer with consultative feedback on topics such as possibly-desirable alternate transactions not meeting said customer-desired characteristics; credit; errors in the data receiving process; and pricing. Note that consultative feedback rules have also been described in connection with the first and second set of business rules; thus, the fact that this third set is generically characterized as a consultative feedback set does not mean that the third set consists solely of consultative feedback rules, and by the same token does not mean that the first and second business rule sets cannot contain consultative feedback business rules as constituents. As noted before, definition of “sets” of rules is to some degree arbitrary/user selectable, and the ability to provide consultative feedback at multiple stages of the system/method is more important than the division of business rules into defined sets, especially given that the sets are interrelated and organically interdependent.

While the third set of business rules may contain a wide variety of rules in the mortgage example, some illustrative rules that may profitably be included in this set would include economic rate and point rules (e.g., rules for calculating pricing, base rates, and rate-point combinations to define a range of diversely-priced products to the customer responsive to customer preferences while maintaining product provider profitability within acceptable rule-defined ranges). The third set of business rules may also be an appropriate set in which to include “relationship pricing” functionality, e.g., special rules requesting from a customer information that will determine his eligibility, if any, for various incentive/preferential pricing structures, for instance. The customer may be recognized as eligible for particular relationship pricing treatment based on self-identification as an employee of a company having a relationship with the product provider, for example, or can automatically be identified by, e.g., his originating URL or home telephone number. Great flexibility as to pricing and other concessions/product characteristics may be obtained by provision of appropriate relationship pricing business rules in conjunction with customer-specific data. In fact, unique pricing structures could be defined not just for all employees of a particular company, but even for individual customers within that employee group, depending on business rationales for granting pricing concessions or other advantages, and upon the willingness of the product provider and/or the provider of the decisioning/feedback system to custom-tailor business rules to this degree of fine granularity. Other business rules in the third set can include fee-related business rules, which, upon eliciting customer-specific or locale-specific additional information relative to the applicant or real property (in a mortgage example), can generate closely-accurate estimates for ancillary fees for a given financial transaction—a point of considerable concern, and a service of considerable value, to cost-sensitive mortgage customers, for example.

While the mortgage example has thus been described in conjunction with three somewhat-arbitrarily defined sets of business rules, the definition of business rule sets will be a matter of discretion (as is the choice of particular business rules), and even the sequence in which the business rules, or any set thereof, may be combined is not limited to the examples just given. Further, additional sets of business rules (a fourth set, etc.) could usefully be defined for performing specialized functions relative to pricing, fulfillment, account management, etc. The important characteristic is the integration of at least some consultative feedback business rules as an integral part of the consumer and provider decisionmaking process, and the consequent ability to create useful permutations of available product to the customer (thus also maximizing potential exposure of salable products of the provider) and display such permutations such that the user may adaptively vary his choices as well as his input data so as to choose from an optimal range of financial services products, including products of which he was not previously aware or as to which he did not realize he could advantageously avail himself. Such functionality may be delivered for a range of financial products and product categories, whether through the internet, through dedicated telephone call centers whose operators implement or have recourse to the system of the present invention, through automatic telephone prompt systems, etc.

Those of ordinary skill in the art will appreciate that the foregoing discussion of certain embodiments and preferred embodiments is illustrative only, and does not limit the spirit and scope of the present invention, which are limited only by the claims set forth below.

We claim:

1. A method for generating decisions relative to a financial transaction between a financial services provider and a potential customer comprising the steps of:
(a) receiving from the customer first data relative to customer-desired characteristics of the financial transaction and second data relative to the customer's attributes;
(b) evaluating said first data using a first set of business rules to determine a first range of available transactions meeting said customer-desired characteristics;
(c) evaluating said second data using a second set of business rules to determine credit-related traits for the customer;
(d) applying a third set of business rules to supply to the customer consultative feedback on at least one topic selected from the group of topics comprising:
(i) possibly-desirable alternate transactions not meeting said customer-desired characteristics;
(ii) credit;
(iii) errors in the data receiving process, whereby the customer is aided in evaluating a range of available financial transactions.

2. The method of claim 1, further comprising the step of closing one of the range of available financial transactions evaluated by the customer.

3. The method of claim 1, further comprising the step of storing in a memory information regarding at least some of said customer-supplied first and second data, whereby the customer is allowed to revisit the evaluation process at a later date without reentering all of said customer-supplied first and second data.

4. The method of claim 1, wherein the customer is linked to the financial services provider by a data network connection.

5. The method of claim 4, wherein said data network connection comprises an internet connection.

6. The method of claim 4, wherein said data network connection comprises a telephone connection to a customer call center having access to computer databases of the financial services provider.

7. The method of claim 5, wherein said internet connection is supplied with high-level encryption for securing of data transmissions to or from the customer.

8. The method of claim 5 or 6, wherein the financial transaction comprises a mortgage loan made to the potential customer.

9. The method of claim 8, wherein the mortgage loan comprises a mortgage in respect of a property selected from the group comprising first purchase money mortgages and second mortgages.

10. The method of claim 8, wherein the mortgage loan comprises a mortgage selected from the group comprising fixed rate mortgages, adjustable rate mortgages, and hybrid mortgages.

11. The method of claim 8, wherein the mortgage loan comprises a mortgage selected from the group comprising conforming and nonconforming mortgages as evaluated by the guidelines of mortgage industry standard-setting bodies.

12. The method of claim 8, wherein said first data relative to customer-desired characteristics of the financial transaction comprise attributes selected from the group comprising mortgage loan amount, the state in which the property to be mortgaged is located, and the number-of-family occupancy of the property to be mortgaged.

13. The method of claim 8, wherein said second data relative to the customer's attributes comprises credit-related attributes for the customer, selected from the group comprising customer income, prior credit experience, and occupation.

14. The method of claim 8, wherein said second set of business rules comprises a creditworthiness risk engine adapted for generation of mortgages such that the mortgages will meet standards of the secondary mortgage market for resale in the secondary mortgage market.

15. The method of claim 8, wherein said third set of business rules comprises:
(a) pricing rules adapted to display accurately the total price to the customer of at least one particular mortgage product for said customer-desired characteristics of the financial transaction;
(b) feedback rules for eliciting and processing of additional customer-selected data input.

16. The method of claim 15, wherein said pricing rules comprise rules selected from the group comprising (i) economic rate and point rules; (ii) marketing pricing rules; and (iii) rules for calculating mortgage-related fees.

17. The method of claim 16, wherein said rules for calculating mortgage-related fees comprise rules for estimating fees selected from the group comprising (A) closing fees, (B) title-related fees; and (C) governmental fees for a mortgage transaction.

18. The method of claim 17, wherein said governmental fees comprise a database of governmental fees for a plurality of discrete governmental jurisdictions, whereby total fees may be assessed with high accuracy across a range of disparate localities.

19. The method of claim 16, wherein said marketing pricing rules comprise relationship pricing rules, whereby pricing may be tailored to classes of borrowers based upon membership in an affinity marketing target group.

20. The method of claim 16, wherein said economic rate and point rules comprise rules for calculating a plurality of possible combinations of mortgage rate and mortgage point offerings, whereby the financial service provider may forecast with accuracy a desired level of mortgage loan profitability.
